(19) United States
(12) Patent Application Publication
(10) Pub. No.: US 2025/0079040 A1
(43) Pub. Date: Mar. 6, 2025

(54) RIBBON CABLE HAVING INDIVIDUALLY-INSULATED WIRES

(71) Applicant: ATL Technology, LLC, Springville, UT (US)

(72) Inventor: Donovan Finnestad, Clackamas, OR (US)

(21) Appl. No.: 18/821,764

(22) Filed: Aug. 30, 2024

Related U.S. Application Data
(60) Provisional application No. 63/535,567, filed on Aug. 30, 2023.

(51) Int. Cl. H01B 7/02; H01B 3/44; H01B 7/08

(52) U.S. Cl. CPC H01B 7/0216; H01B 3/447; H01B 7/0823; H01B 7/0876; H01B 7/0892

(57) ABSTRACT

An example of the present disclosure includes a ribbon cable. The ribbon cable includes a plurality of wires, each wire of the plurality of wires being a different wire type of a plurality of wire types relative to the wire type of at least another one of the plurality of wires. Each one of the plurality of wires includes a conductor and an outer insulating layer surrounding a perimeter of the conductor. The outer insulating layer of a first wire includes a portion located between the conductor of the first wire and the conductor of a second wire adjacent to the first wire. The ribbon cable includes an adhesive material exterior to the outer insulating layer of each wire of the plurality of wires and bonding together the plurality of wires.

### CROSS-REFERENCE TO RELATED APPLICATION

This application claims the benefit of U.S. Provisional Patent Application No. 63/535,567, filed Aug. 30, 2023, which is incorporated herein by reference in its entirety.

### FIELD

This disclosure relates generally to ribbon cables having multiple wires and more particularly to ribbon cables having individually-insulated wires.

### BACKGROUND

Cables are often used to transmit electrical signals or to provide power. A ribbon cable typically includes a number of parallel conductors that are held together in a ribbon-like arrangement. Forming multiple wires, each having its own insulated, protective layer, into a ribbon cable can be difficult, especially when the wires are small.

### SUMMARY

The subject matter of the present application has been developed in response to the present state of the art, and in particular, in response to the shortcomings of multi-wire ribbon cables that have not yet been fully solved by currently available techniques. Accordingly, the subject matter of the present application has been developed to provide a ribbon cable having multiple individually-insulated wires that overcomes at least some of the above-discussed shortcomings of prior art techniques.

Disclosed herein is a ribbon cable. The ribbon cable includes a plurality of wires, each wire of the plurality of wires being a different wire type of a plurality of wire types relative to a wire type of at least another wire of the plurality of wires. Each one of the plurality of wires includes a conductor and an outer insulating layer surrounding a perimeter of the conductor. The outer insulating layer of a first wire includes a portion located between the conductor of the first wire and the conductor of a second wire adjacent to the first wire. The ribbon cable also includes an adhesive material exterior to the outer insulating layer of each wire of the plurality of wires and bonding together the plurality of wires. The preceding subject matter of this paragraph characterizes example 1 of the present disclosure.

The plurality of wire types includes at least one of the following: solid wire, stranded wire, coaxial cable, twisted pair cable, fiber optic cable, or any combination thereof. The preceding subject matter of this paragraph characterizes example 2 of the present disclosure, wherein example 2 also includes the subject matter according to example 1, above.

An outer insulating layer of a first wire of the plurality of wires is made of a first material and an outer insulating layer of a second wire of the plurality of wires is made of a second material different from the first material. The preceding subject matter of this paragraph characterizes example 3 of the present disclosure, wherein example 3 also includes the subject matter according to any of examples 1-2, above.

The adhesive material includes an acrylic, UV-curable material. The preceding subject matter of this paragraph characterizes example 4 of the present disclosure, wherein example 4 also includes the subject matter according to any of examples 1-3, above.

A first wire of the plurality of wires is arranged substantially parallel and co-planar with a second wire of the plurality of wires. The preceding subject matter of this paragraph characterizes example 5 of the present disclosure, wherein example 5 also includes the subject matter according to any of examples 1-4, above.

At least one wire of the plurality of wires includes a number of wires twisted together. Each wire of the number of wires includes a conductor, a dielectric layer, and an outer insulating layer. The preceding subject matter of this paragraph characterizes example 6 of the present disclosure, wherein example 6 also includes the subject matter according to any of examples 1-5, above.

The plurality of wires include one or more wires located between two twisted wires. The preceding subject matter of this paragraph characterizes example 7 of the present disclosure, wherein example 7 also includes the subject matter according to any of examples 1-6, above.

The outer insulating layer of at least one wire of the plurality of wires is made of polyethylene. The preceding subject matter of this paragraph characterizes example 8 of the present disclosure, wherein example 8 also includes the subject matter according to any of examples 1-7, above.

The adhesive material has a Young's modulus not greater than 4.0. The preceding subject matter of this paragraph characterizes example 9 of the present disclosure, wherein example 9 also includes the subject matter according to any of examples 1-8, above.

Each wire of the plurality of wires further includes a metallic layer disposed between the outer insulating layer and the conductor and a dielectric material disposed between the metallic layer and the conductor. The preceding subject matter of this paragraph characterizes example 10 of the present disclosure, wherein example 10 also includes the subject matter according to any of examples 1-9, above.

The adhesive material bonds together the plurality of wires intermittently along a length of the ribbon cable. The preceding subject matter of this paragraph characterizes example 11 of the present disclosure, wherein example 11 also includes the subject matter according to any of examples 1-10, above.

Further disclosed herein is a method of manufacturing a ribbon cable that includes shaping, via a first die of a die assembly, a plurality of wires into a ribbon cable having a first shape. The method also includes applying an adhesive material onto the plurality of wires, the adhesive material comprising a UV-curable acrylic material. The method further includes removing a portion of the adhesive material from the wires of the plurality of wires by moving the plurality of wires through a felt layer of the die assembly. The method additionally includes adjusting, via a second die of the die assembly, a shape of the plurality of wires from the first shape to a second shape. The method also includes curing the adhesive material by exposing the adhesive material 120 to a light source for a time interval. The preceding subject matter of this paragraph characterizes example 12 of the present disclosure.

The light source is a UV light source coupled to the die assembly. The preceding subject matter of this paragraph characterizes example 13 of the present disclosure, wherein example 13 also includes the subject matter according to example 12, above.

The method further includes exposing the adhesive material to an additional UV light source for an additional time interval. The additional UV light source is separate from the die assembly, and the additional time interval is greater than the time interval. The preceding subject matter of this paragraph characterizes example 14 of the present disclosure, wherein example 14 also includes the subject matter according to example 13, above.

The method also includes applying the adhesive material between a first wire of the plurality of wires and a second wire of the plurality of wires. The preceding subject matter of this paragraph characterizes example 15 of the present disclosure, wherein example 15 also includes the subject matter according to any of examples 12-14, above.

The method additionally includes applying the adhesive material to the plurality of wires such that the adhesive material surrounds the plurality of wires. The preceding subject matter of this paragraph characterizes example 16 of the present disclosure, wherein example 16 also includes the subject matter according to any of examples 12-15, above.

The method further includes opening the die assembly to receive the plurality of wires between a first plate of the die assembly and a second plate of the die assembly. The preceding subject matter of this paragraph characterizes example 17 of the present disclosure, wherein example 17 also includes the subject matter according to any of examples 12-16, above.

The method also includes adjusting a pressure level used to remove the portion of the adhesive material based at least in part on a pre-determined cable fillet size. The preceding subject matter of this paragraph characterizes example 18 of the present disclosure, wherein example 18 also includes the subject matter according to any of examples 12-17, above.

The method additionally includes forming an outer insulating layer around each wire of the plurality of wires prior to applying the adhesive material. The preceding subject matter of this paragraph characterizes example 19 of the present disclosure, wherein example 19 also includes the subject matter according to any of examples 12-18, above.

Additionally disclosed herein is a system that includes a die assembly. The die assembly includes a first plate. The die assembly also includes a second plate including a groove configured to receive a plurality of wires. The die assembly further includes a first die coupled to the second plate and comprising a first groove corresponding to a pre-form shape of a ribbon cable. The die assembly additionally includes a reservoir located to intersect the plurality of wires when the plurality of wires are received by the second plate. The die assembly also includes an applicator configured to feed an adhesive material into the reservoir. The die assembly further includes a felt layer configured to remove a portion of the adhesive material the plurality of wires. The die assembly additionally includes a second die including a second groove corresponding to a final-form shape of the ribbon cable. The system also includes an ultraviolet (“UV”) light source coupled to the first plate and configured to partially cure the adhesive material by exposing it to UV light for a time interval. The system further includes additional UV light sources configured to further cure the adhesive material. The preceding subject matter of this paragraph characterizes example 20 of the present disclosure.

The described features, structures, advantages, and/or characteristics of the subject matter of the present disclosure may be combined in any suitable manner in one or more examples and/or implementations. In the following description, numerous specific details are provided to impart a thorough understanding of examples of the subject matter of the present disclosure. One skilled in the relevant art will recognize that the subject matter of the present disclosure may be practiced without one or more of the specific features, details, components, materials, and/or methods of a particular example or implementation. In other instances, additional features and advantages may be recognized in certain examples and/or implementations that may not be present in all examples or implementations. Further, in some instances, well-known structures, materials, or operations are not shown or described in detail to avoid obscuring aspects of the subject matter of the present disclosure. The features and advantages of the subject matter of the present disclosure will become more fully apparent from the following description and appended claims, or may be learned by the practice of the subject matter as set forth hereinafter.

### BRIEF DESCRIPTION OF THE DRAWINGS

In order that the advantages of the subject matter may be more readily understood, a more particular description of the subject matter briefly described above will be rendered by reference to specific examples that are illustrated in the appended drawings. Understanding that these drawings, which are not necessarily drawn to scale, depict only certain examples of the subject matter and are not therefore to be considered to be limiting of its scope, the subject matter will be described and explained with additional specificity and detail through the use of the drawings, in which:

FIG. 1A is a perspective view of a ribbon cable, according to one or more examples of the present disclosure;

FIG. 1B is a cross-sectional view of a ribbon cable, taken along plane B in FIG. 1A, according to one or more examples of the present disclosure;

FIG. 1C is a top plan view of a ribbon cable, according to one or more examples of the present disclosure;

FIG. 1D is a cross-sectional view of a ribbon cable, taken along plane C in FIG. 1C, according to one or more examples of the present disclosure;

FIG. 2A is a perspective view of system for forming a ribbon cable, showing a die assembly of the system enclosing wires of the ribbon cable, according to one or more examples of the present disclosure;

FIG. 2B is a perspective view of the system of FIG. 2A, showing a top half of the die assembly removed to show wires passing through a leading die and a trailing die of the die assembly, according to one or more examples of the present disclosure;

FIG. 2C is perspective view of a system for forming a ribbon cable, showing a top half of the die assembly removed to show wires passing through a leading die and a trailing die of the die assembly, according to one or more examples of the present disclosure;

FIG. 3 is a perspective view of a die assembly of a system for forming a ribbon cable, according to one or more examples of the present disclosure;

FIG. 4 is a perspective view of an array of ultraviolet (“UV”) light sources of a system for forming a ribbon cable, according to one or more examples of the present disclosure; and

FIG. 5 is a schematic flow chart of a method of manufacturing a ribbon cable, according to one or more examples of the present disclosure.

### DETAILED DESCRIPTION

Reference throughout this specification to “one example,” “an example,” or similar language means that a particular feature, structure, or characteristic described in connection with the example is included in at least one example of the present disclosure. Appearances of the phrases “in one example,” “in an example,” and similar language throughout this specification may, but do not necessarily, all refer to the same example. Similarly, the use of the term “implementation” means an implementation having a particular feature, structure, or characteristic described in connection with one or more examples of the present disclosure, however, absent an express correlation to indicate otherwise, an implementation may be associated with one or more examples.

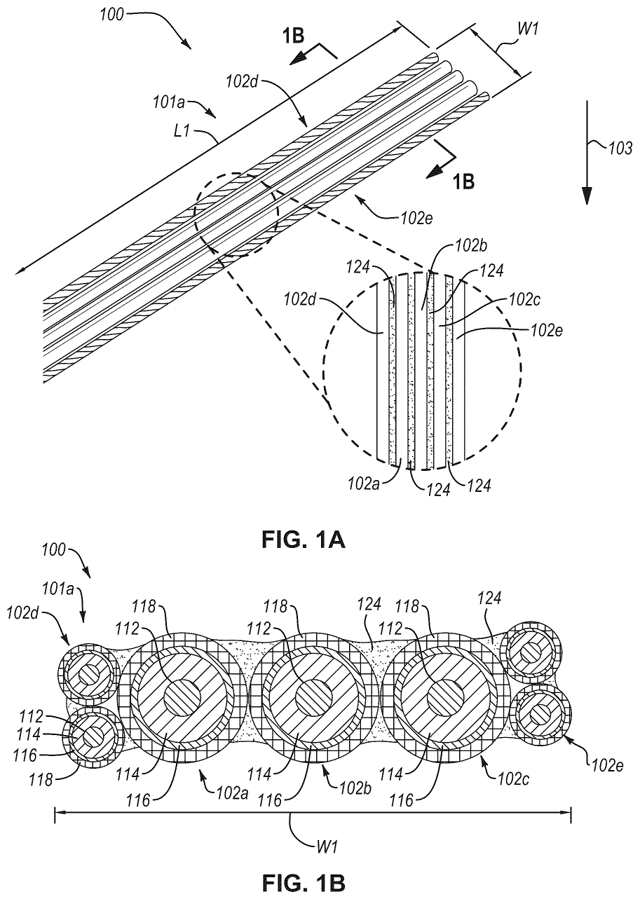

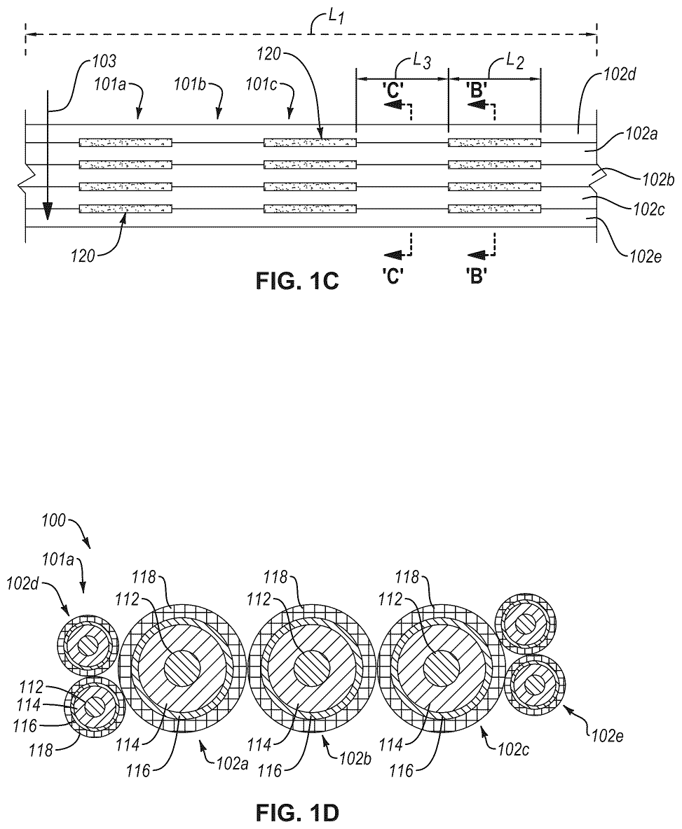

Referring to FIGS. 1A and 1B, one example of a ribbon cable 100 is shown. The ribbon cable 100 extends lengthwise along a length L1 of the ribbon cable 100. The plane ‘B’ is perpendicular to the length L1 and parallel to a width W1 of the ribbon cable 100. The ribbon cable 100 includes multiple wires 102a, 102b, . . . , 102e (also referred to herein, individually or collectively, as “102”) coupled together to form a ribbon-like structure. Each one of the wires 102 includes at least one conductor 112. Also, each one of the wires 102 includes an outer insulating layer 118. The outer insulating layer 118 surrounds the conductor 112. Each one of the wires 102 additionally includes a dielectric layer 114 between the conductor 112 and the outer insulating layer 118. The outer insulating layer 118 and the dielectric layer 114 are concentric with the conductor 112. Generally, the conductor 112 is made of an electrically-conductive material, such as metal (e.g., copper), the outer insulating layer 118 is made of a heat insulating material, such as a first type of polymer, and the dielectric layer 114 is made of a dielectric material, such as a second type of polymer. The ribbon cable 100 is substantially flat in a plane perpendicular to the plane ‘B’. Each one of the wires 102 of the ribbon cable 100 extends substantially parallel to each other along the length L1 of the ribbon cable 100 and has the same length as the ribbon cable 100. In some examples, at least some of the wires 102 or all of the wires 102 are co-planar or lie within the same plane.

As shown in FIG. 1B, in one example, the wires 102 of the ribbon cable 100 include a first wire 102a, a second wire 102b, a third wire 102c, a fourth wire 102d, and a fifth wire 102e. In some examples, the type of each one of the first wire 102a, the second wire 102b, the third wire 102c, the fourth wire 102d, and the fifth wire 102e is different than at least one other one of the first wire 102a, the second wire 102b, the third wire 102c, the fourth wire 102d, and the fifth wire 102e. The type of a wire is defined by the structure of the wire, which can be defined as the type (e.g., quantity, material, size, shape, color, etc.) of the conductor 112, the dielectric layer 114, or the outer insulating layer 118. Accordingly, as defined herein, one wire 102 is a different type of wire than another when at least one characteristic of the structure of the wire 102 is different than that of the other wire 102. Some different wire types include, for example, solid wire, stranded wire, coaxial cable, twisted pair cable, fiber optic cable, or any combination thereof. In the illustrated example, the first wire 102a, the second wire 102b, and the third wire 102c are single conductor wires, and the fourth wire 102d and the fifth wire 102e are twisted cable wires. As such, the cable 100 includes at least one wire (e.g., the first wire 102a, second wire 102b, and/or 102c) located between two twisted cable wires 102d and 102e. Each one of the fourth wire 102d and the fifth wire 102e includes multiple twisted wires, each wire having its own conductor 112, dielectric layer 114, and outer insulating layer 118.

Because each one of the wires 102 includes its own outer insulating layer 118, a portion of the outer insulating layer 118 of one of the wires 102 is interposed between the conductor 112 of that wire and the outer insulating layer 118 of an adjacent one of the wires 102. For example, the outer insulating layer 118 of the first wire 102a is interposed between the conductor 112 of the first wire 102a and the outer insulating layer 118 of the second wire 102b.

In some examples, each one of the wires 102 of the ribbon cable 100 also includes a shield layer 116 disposed between and concentric with the outer insulating layer 118 and the conductor 112. The shield layer 116 can be made of a metallic material, which can be braided in some examples. The shield layer 116 helps to prevent interfering signals from the inside of the wire 102 from reaching the outside and disturbing other wires 102, or even electrical devices, and helps ensure that external interference does not reach the inside of the wire 102.

In some examples, each one of the outer insulating layers 118 of the first wire 102a, the second wire 102b, and the third wire 102c are made of the same material. In other examples, the outer insulating layer 118 of one of the first wire 102a, the second wire 102b, and the third wire 102c is made of a material different than the outer insulating layer 118 of another one of the first wire 102a, the second wire 102b, and the third wire 102c. In some examples, the outer insulating layer 118 is made of polyethylene. For example, the outer insulating layer 118 can be made of polyethylene terephthalate. In some examples, the type of material for the outer insulating layer 118 depends on the type of wire 102 and/or the type of conductor 112. As shown in FIG. 1A, in some examples, the colors of the outer insulating layers 118 of each wire 102 are different to aid in visual differentiation of the different types of wires. In certain examples, the wire types of the twisted wires forming the fourth wire 102d are the same, and the wire types of the twisted wires forming the fifth wire 102e are the same. However, the twisted wires forming the fourth wire 102d can be a different type than the twisted wires forming the fifth wire 102e. In some examples, each one of the wires 102-of the ribbon cable 100 has an impedance of not less than 20Ω and not greater than 80Ω.

In some examples, each one of the wires 102 of the ribbon cable 100 has a diameter that is not less than 0.02 millimeters (“mm”) and not greater than 0.035 mm. In some examples, each one of the wires 102 has a diameter not less than 0.0254 mm and not greater than 0.381 mm. In some examples, each one of the wires 102 has an American Wire Gauge (AWG) sizes of at least 40 AWG and not more than 50 AWG. In some examples, the width W1 of the ribbon cable 100 is not less than 0.12 mm and not greater than 3.9 mm.

Although not shown, in some examples, the ribbon cable 100 includes at least one wire that is a flat composite structure coax wire. In some examples, the ribbon cable 100 includes a wire that is shaped similarly to the overall shape of the ribbon cable 100. In such examples, the wire includes an inner conductor that is thinner and flatter than the wires 102a-102c shown in the figures. In some examples, the ribbon cable 100 includes a flat composite structure coax wire that has a dielectric layer surrounding the inner conductor and an outer conductor separated from the inner conductor by the dielectric layer. In some examples, the outer conductor is a braided copper shield.

The ribbon cable 100 further includes an adhesive material 120 exterior to, or on the outside of, the wires 102 that couples (e.g., attaches or bonds) the wires 102 together. In some examples, the adhesive material 120 surrounds an entirety of a circumferential perimeter of each one of the wires 102. However, in other examples, the adhesive material 120 surrounds only a portion of the circumference or perimeter of each one of the wires 102, such as just the portions of the wires 102 immediately adjacent each other as shown in FIG. 1B. When the adhesive material 120 surrounds only portions of the perimeters of the wires 102, as shown, in a circumferential direction 103 about the ribbon cable 100, the adhesive material 120 includes multiple separate and spaced-apart adhesive-material segments. Each one of the segments of the adhesive material 120 defines a fillet 124 between two adjacent ones of the wires 102.

The adhesive material 120 attaches or bonds the plurality of wires 102 together to maintain the wires 102 in the ribbon arrangement. In some examples, the adhesive material 120 extends along an entire length of the wires 102. However, referring to FIG. 1C, in other examples, the adhesive material 120 is intermittently dispersed along the lengths of the wires 102 to form multiple spaced-apart segments of the adhesive material 120 in the lengthwise direction.

In some examples, a wire 102 of the ribbon cable 100 can be removed from an adjacent wire 102 of the ribbon cable 100 by tearing the adhesive material 120 between the wires 102. For example, the first wire 102a can be removable from the second and third wires 102b, 102c notwithstanding the adhesive material 120 between the first wire 102a, the second wire 102b, and the third wire 102c. As such, in some examples, the size of the ribbon cable 100 can be reduced even after the adhesive material 120 joins the wires 102 together.

In some examples, the adhesive material 120 is made of a UV-curable adhesive. In certain examples, the adhesive material 120 is an acrylic material, such as acrylated urethane. According to some examples, the refractive index of the adhesive material 120, before curing, is greater than 1.45 and less than 1.55. In some examples, the specific gravity of the adhesive material 120, before curing and at 25 degrees Celsius, is greater than 1.0 and not less than 1.25.

The adhesive material 120 is flexible after curing. For example, after curing, the adhesive material 120 includes a material having a Young's modulus not greater than 4.0. In some examples, the adhesive material 120, after curing, includes a material having a tensile modulus of not less than 180 and not greater than 230 N/mm². In some examples, after curing, the adhesive material 120 has a tensile strength at break of not less than 15 and not greater than 20 N/mm².

In some examples, after curing, the adhesive material 120 has a surface resistivity of greater than or equal to 9×10¹⁴ Ωcm and a volume resistivity of greater than or equal to 7×10¹⁴ Ωcm. In some examples, after curing, the adhesive material 120 has a dielectric breakdown strength that is not less than 20 and not greater than 20 kV/mm.

In some examples, after curing, the adhesive material 120 is at least partially transparent. As such, after curing, the adhesive material 120 allows for different colors identifying the different wires 102 to be discernible. In some examples, curing the adhesive material 120 includes exposing the adhesive material 120 to light having a wavelength of not less than 300 nm and not greater than 450 nm. For example, the light has a wavelength of approximately 365 nm. After curing the adhesive material 120 for five seconds, the adhesive material 120 has a shear strength of not less than 0.1 N/mm². However, examples of the present disclosure include curing the adhesive material 120 for longer than five seconds, yielding greater shear strength. For example, the adhesive material 120 is bonded for a period of time that is not less than five seconds and not greater than ten seconds.

Referring to FIG. 1A, in some examples, the ribbon cable 100 is ribboned (e.g., has bonded together wires) continuously along an entire length L1 of the ribbon cable 100. Accordingly, in such examples, the ribbon cable 100 effectively has a continuous ribboned portion extending along the entire length L1 of the ribbon cable 100. However, referring to FIGS. 1C and 1D, in other examples, the ribbon cable 100 includes both ribboned portions 101a and non-ribboned portions 101b along its length L1. While the ribboned portions 101a include adhesive material 120 forming the fillets 124, the non-ribboned portions 101b include sections of the wires 102 that are not bound together by adhesive material 120. Dispersing non-ribboned portions 101b intermittently along the length L1 of the ribbon cable 100 helps to increase flexibility of the ribbon cable 100, while still keeping the wires 102 of the ribbon cable 100 bound together in the ribbon arrangement. In some examples, the ribbon cable 100 includes a quantity of ribboned portions 101a that is equal to the quantity of non-ribboned portions 101b. In other examples, the quantity of ribboned portions 101a is one greater than the quantity of non-ribboned portions 101b. For example, the ribboned portions 101a can be located at both ends of the ribbon cable 100.

Referring to FIG. 1C, in some examples, a length L2 of each one of the ribboned portions 101a is approximately equal to a length L3 of each one of the non-ribboned portions 101b. In other examples, however, the lengths L2 and L3 can be different. In one example, such as shown, the length L3 of the non-ribboned portions 101b is less than the length L2 of the ribboned portions 101a. However, in other examples, the length L2 of the ribboned portion 101a is less than the length L3 of the non-ribboned portion 101b. In certain examples, the length L2 of the ribboned portion 101a is not less than 0.5 centimeters (“cm”).

Referring to FIG. 1D, as shown cross-sectionally along a plane ‘C’ that is perpendicular to the length L1 of the ribbon cable 100, parallel to the plane ‘B’, and passes through one of the non-ribboned sections 101b, spacing between the wires 102 can be greater along the non-ribboned sections 101b than along the ribboned sections 101a. This variation in spacing is enabled because of the lack of the adhesive material 120 binding together the wires 102 in the non-ribboned sections 101b. This variability in spacing, enabled by the non-ribboned sections 101b, facilitates greater flexibility in the shapes (e.g., enables tighter bends) the ribbon cable 100 is able to be formed into.

In some examples, the ribbon cable 100 forms part of a device or facilitates electrical connection for a device configured to be inserted into a human body. For example, the ribbon cable 100 has a width W1 sufficiently small for use in endoscopic applications. In some examples, the ribbon cable 100 is a catheter guidewire, such as an optical guidewire associated with a camera.

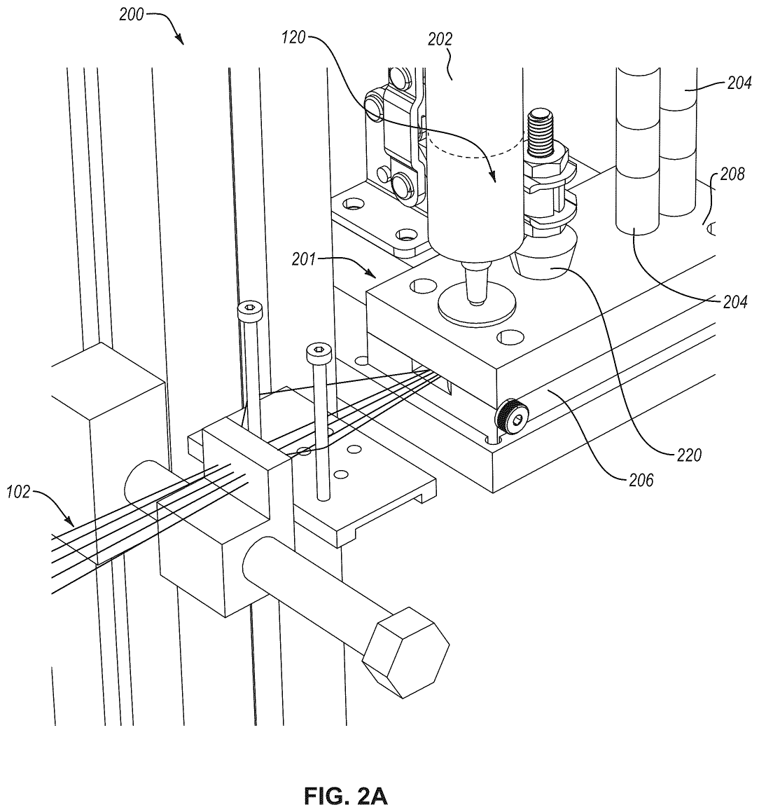

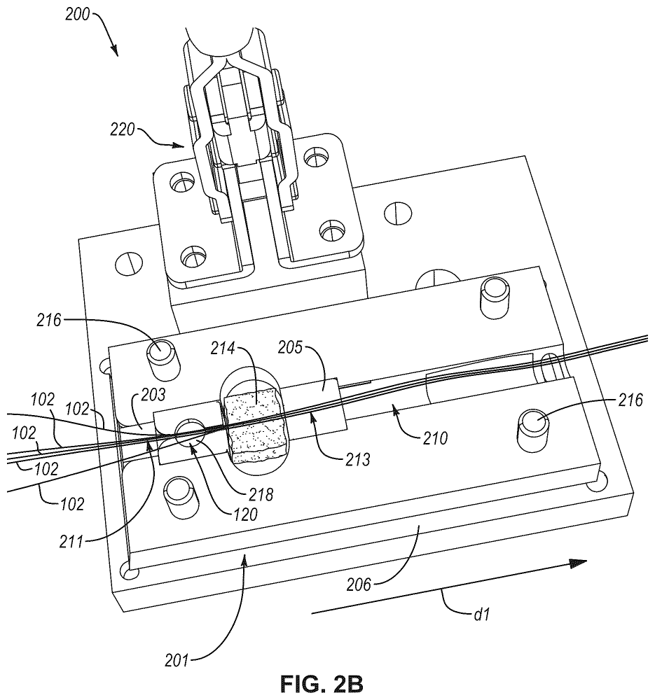

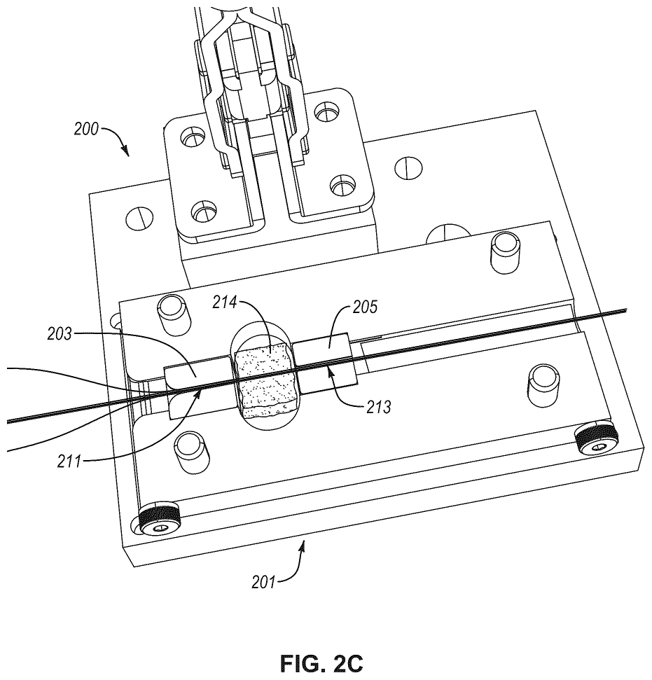

Referring to FIGS. 2A-4, some examples of a system 200 for making the ribbon cable 100 are shown. The system 200 includes a die assembly 201 configured to receive a continuous supply of wires 102 (e.g., different types of wires 102), which converge at a leading die 203 of the die assembly 201, position the wires 102 into a ribbon arrangement, maintain the shape of the ribbon arrangement as adhesive material 120 is supplied to the wires 102, and maintain the shape of the ribbon arrangement as the wires 102 move through the trailing die 205 of the die assembly 201. In some examples, the wires 102 are maintained in a ribbon arrangement as their entire lengths are fed through and exit a trailing die 205 of the die assembly 201. In some examples, the adhesive material 120 is supplied along the entire length of the wires 102 to form a ribbon cable 100 with a single, continuous ribboned portion 101a along the length L1 of the ribbon cable 100. In other examples, the supply of adhesive material 120 to the wires 102 is interrupted intermittently at predetermined times to form a ribbon cable 100 having both ribboned portions 101a and non-ribboned portions 101b, as shown in FIGS. 1C-1D, each having predetermined lengths corresponding with the predetermined interruption times.

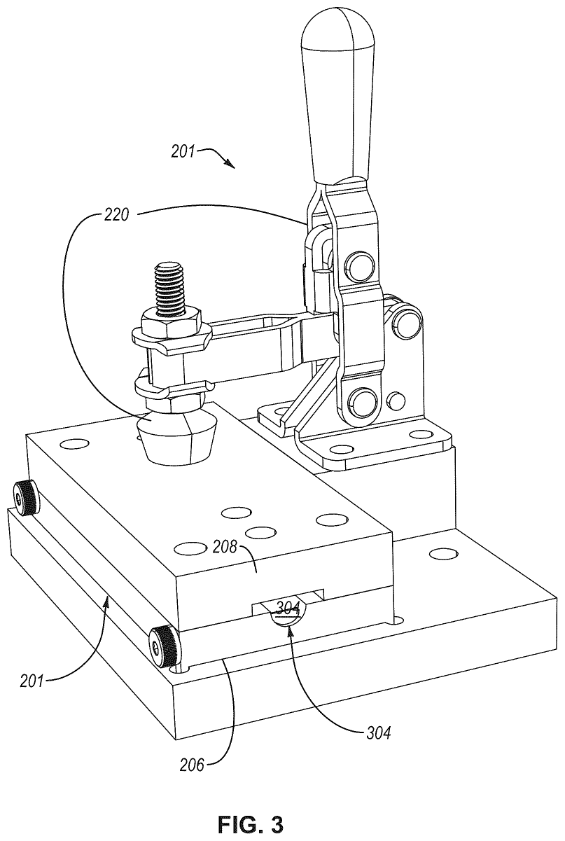

As shown in FIG. 2A, a desired number of wires 102 are fed continuously through the leading die 203. The individual wires 102 are pre-formed prior to being fed into the leading die 203. In other words, the outer insulating layers 118 of the wires 102 are fully formed prior to feeding the wires 102 through the leading die 203. The process described in connection with FIGS. 2A-3 temporarily bonds together wires 102 in the ribbon arrangement.

The die assembly 201 includes a first plate 208 (e.g., top half) and a second plate 206 (e.g., bottom half). The first plate 208 rests on the second plate 206 and is adjustably moveable toward the first plate 208 to apply an adjustable pressure relative to the first plate 208. Alignment between the first plate 208 and the second plate 206 is facilitated by engagement between alignment posts 216 in one of the first plate 208 or the second plate 206, and corresponding recesses in the other of the first plate 208 and the second plate 206. The second plate 206 defines a groove 210 or pocket. Each of the leading die 203, a felt material 214 of the die assembly 201, and the trailing die 205 rest within the groove 210. The leading die 203 and/or the trailing die 205 include molding grooves 211 and 213, respectively, formed therein. The molding grooves 211 and 213 are shaped according to a desired pre-form shape and final-form shape of the ribbon cable 100, respectively. In some examples, one or both of the molding grooves 211 and 213 includes a number of wire-positioning features. For example, the molding groove 211 can include an array of channels each shaped to receive a corresponding one of the wires 102. Similarly, in certain examples, the molding groove 213 includes an array or channels each shaped to receive a corresponding one of the wires 102. In one example, the spacing of the array of channels, relative to each other, of the molding groove 211 is different than the spacing of the array of the channels, relative to each other, of the molding groove 213.

As the wires 102 converge at the leading die 203, the molding groove 211 of the leading die 203 arranges (e.g., shapes) the wires 102 into the pre-shape of the ribbon cable 100, conducive to receiving adhesive, and the molding groove 213 of the trailing die 205 further arranges (e.g., shapes) the wires 102 after adhesive is applied into a final-form shape of the ribbon cable 100 in preparation for the adhesive to be cured.

The system 200 further includes an adhesive applicator 202 filled with the adhesive material 120. The adhesive applicator 202 is positioned above an adhesive reservoir 218 of the die assembly 201. The first plate 208 includes an aperture through which the adhesive material 120 is fed into the adhesive reservoir 218. In some examples, the adhesive material 120 is gravity fed into the adhesive reservoir 218. In some examples, the adhesive material 120 is fed into the adhesive reservoir 218 via pressurized dispensing. As the wires 102 are passed through the adhesive reservoir 218, adhesive material 120 in the reservoir 218 coats the wires 102 (e.g., surrounds the wires 102). The coated wires 102 then pass between two layers of felt material 214. The felt material 214 removes some of the adhesive material 120 from the wires 102 so that a desired quantity or thickness remains on the wires 102 (e.g., thickness or size of fillets between adjacent wires on top and bottom of wires). The quantity of adhesive material 120 removed is adjustable by adjusting the compressive pressure of the felt against the wires 102 (e.g., through the pressure applicator 220). Applying more pressure removes more adhesive material 120 and lowers the quantity or thickness of adhesive material 120 on wires 102. Pressure can be adjusted by adjusting a pressure applicator 220 of the system 200. After removing part of the adhesive material 120 via the felt material 214, the wires 102 pass through the trailing die 205, which further shapes the cable 100. In some examples, the leading die 203 and/or the trailing die 205 can removable and replaceable. For example, replacing the leading die 203 and/or the trailing die 205 with other dies having a groove with a different dimension can help adjust a shape of the ribbon cable 100.

In some examples, to form a ribbon cable 100 with both non-ribboned portions 101b and ribboned portions 101a, the pressure applicator 220 is adjusted intermittently as the wires 102 are passed through the adhesive reservoir 218. The pressure applicator 220 can be adjusted intermittently such that the adhesive material 120 is not applied to certain portions of the wires 102 (e.g., the portions that form the non-ribboned portions 101b) but is applied to other portions of the wires 102 (e.g., the portions that form the ribboned portions 101a).

The first plate 208 and the second plate 206 can be separated from each other before the entire length of the wires 102 have been fed through the die assembly 201. For example, the first plate 208 and the second plate 206 are separated after forming a first ribboned portion 101a of the ribbon cable 100. The wires 102 can then be adjusted, and the first plate 208 and the second plate 206 can be moved towards each other again, such that the first plate 208 and the second plate 206 are enclosed around a different portion of the wires 102 that is not continuous with the first ribboned portion 101a. As such, components of the die assembly 201 can be moved to interrupt the adhesive application process, creating a continuous ribbon cable 100 with intermittent ribboned portions 101a and non-ribboned portions, as shown in FIG. 1C.

Referring to FIG. 2C, in some examples, the system 200 does not include an adhesive reservoir 218. Rather, the adhesive material 120 is applied directly onto the wires 102 after they exit the leading die 203, such as when they pass over the felt material.

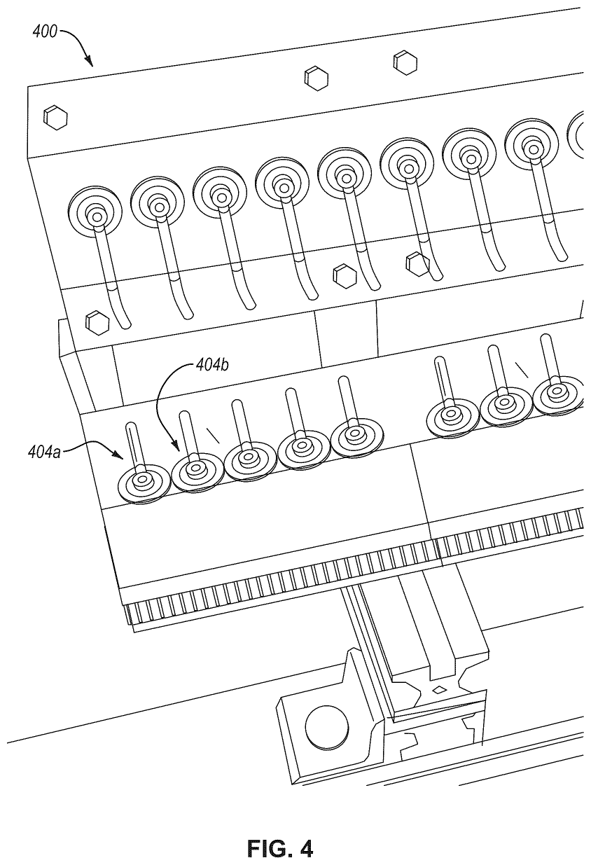

Referring to FIG. 2A, the system 200 further includes UV light sources 204. After leaving the felt material, the coated wires 102 pass below the UV light sources 204, and light from the UV light sources 204 spot cures the adhesive material 120 to hold the wires 102 together before exposing them to a final application of UV light. As shown in FIG. 2A, in some examples, the UV light sources 204 can be coupled to the first plate 208. A method of manufacturing the ribbon cable 100 includes exposing the adhesive material 120 to the one or more UV light sources 204. For example, the method includes exposing the adhesive material 120 to the UV light sources 204 after bringing the wires 102 through the trailing die 205, but before exposing the wires 102 to additional UV lights 404. In some examples, the system 200 includes UV light sources 404 arranged in an array outside of the die assembly 201, as shown in FIG. 4.

FIG. 2B is a perspective view of an opened die assembly 201 receiving wires 102 of a cable 100, according to one or more examples of the present disclosure. As shown in FIG. 2B, the die assembly 201 includes the felt material 214. A method of manufacturing the ribbon cable 100 includes removing a portion of the adhesive material 120 from the plurality of wires 102 via the felt material. For example, the wires 102 are pulled through the leading die 203 in a first direction d1 such that they are exposed first to the adhesive material 120, to the felt material 214, and then to the UV light source(s) 204. In some examples, the wires 102 are pulled through the trailing die 205 in a first direction d2 such that the wires 102 are further shaped after exposure to the felt material 214 but before exposure to the UV light sources 204.

In some examples, adjusting a pressure level of the felt material against the wires 102 can adjust the amount of adhesive material 120 removed and the wires 102. For example, a higher level of pressure can result in smaller fillets 124 (see, e.g., FIG. 1B), rendering a cable 100 with wires 102 that are easier to remove from each other. A lower level of pressure can result in larger fillets 124, rendering a cable 100 with wires 102 that are more difficult to remove. As such, in some examples, a method includes adjusting a pressure level used to remove the portion of the adhesive material 120 based at least in part on a desired fillet size. In some examples, the method include adjusting a pressure level via a pressure applicator 220, which applies pressure to the first plate 208 of the die assembly 201, and thus to the felt material. In some examples, a method includes adjusting a pressure level of the felt material against the wires 102 intermittently to completely remove the adhesive material 120 from the wires 102 along certain portions of the wires (e.g., to form the non-ribboned portions 101b shown in FIG. 1C).

FIG. 3 is a perspective view of the die assembly 201 in a closed position, according to one or more examples of the present disclosure. As shown in FIG. 3, the die assembly 201 includes an opening 304 to receive the plurality of wires 102. The die assembly 201 includes a first plate 208 and a second plate 206. As shown in FIG. 3, when the die assembly 201 is closed, the first plate 208 contacts the second plate 206. In some examples, the method includes opening the die assembly 201 to receive the wires 102 between the first plate 208 and the second plate 206. The first plate 208 can be substantially flat against the second plate 206, and the second plate 206 includes the groove 210, which can define part of the opening 304.

FIG. 4 is a perspective view of a group 400 of additional UV light sources 404 that are separate from the UV light sources 204 attached to the first die assembly 201, according to one or more examples of the present disclosure. In some examples, methods of manufacturing the ribbon cable 100 include exposing the adhesive material 120 to the additional UV light sources 404 after spot curing the adhesive material 120 through exposure to the UV light sources 204. In some examples, the adhesive material 120 is exposed, while maintaining the wires 102 together via the spot cure from the UV light sources 204, to the UV light sources 404 for a time period that is longer than its exposure to the UV light sources 204 of the die assembly 201.

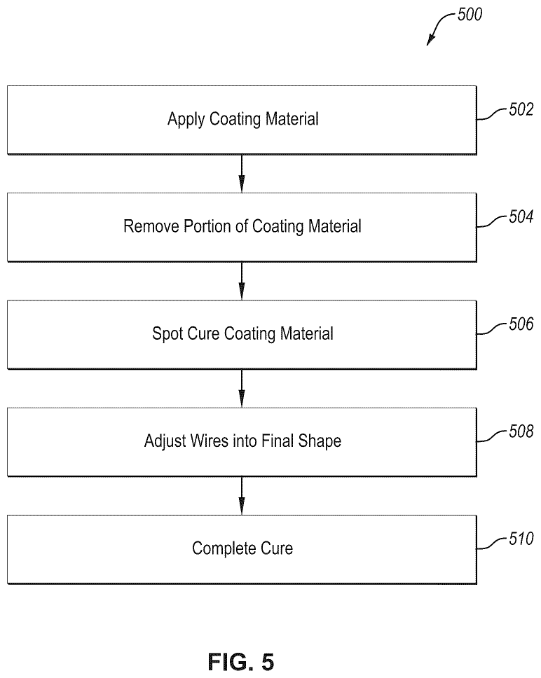

FIG. 5 is a schematic flow chart of a method of manufacturing a cable, according to one or more examples of the present disclosure. The method 500 begins and applies 502 an adhesive material 120 to a plurality of wires 102 after passing through a first die. The adhesive material 120 is a UV-curable acrylic material in some examples. The method 500 further includes removing 504, via a felt material 214, a portion of the adhesive material 120 from the wires 102. The method 500 further includes adjusting 506 a shape of the wires 102 into a final shape via a second die. The method 500 also includes exposing 508 the adhesive material 120 to a UV light source 204 for a time interval to spot cure the adhesive material 120. The method 500 additionally includes exposing 510 the wires 102 to an additional number of UV light sources 404 to permanently or finally cure the adhesive material 120. In some examples, the time interval for which the adhesive material 120 is exposed to additional number of UV light sources 404 is longer than the time interval for which the adhesive material 120 is exposed to the UV light source 204.

In the above description, certain terms may be used such as “up,” “down,” “upper,” “lower,” “horizontal,” “vertical,” “left,” “right,” “over,” “under” and the like. These terms are used, where applicable, to provide some clarity of description when dealing with relative relationships. But, these terms are not intended to imply absolute relationships, positions, and/or orientations. For example, with respect to an object, an “upper” surface can become a “lower” surface simply by turning the object over. Nevertheless, it is still the same object. Further, the terms “including,” “comprising,” “having,” and variations thereof mean “including but not limited to” unless expressly specified otherwise. An enumerated listing of items does not imply that any or all of the items are mutually exclusive and/or mutually inclusive, unless expressly specified otherwise. The terms “a,” “an,” and “the” also refer to “one or more” unless expressly specified otherwise. Further, the term “plurality” can be defined as “at least two.” Moreover, unless otherwise noted, as defined herein a plurality of particular features does not necessarily mean every particular feature of an entire set or class of the particular features.

Additionally, instances in this specification where one element is “coupled” to another element can include direct and indirect coupling. Direct coupling can be defined as one element coupled to and in some contact with another element. Indirect coupling can be defined as coupling between two elements not in direct contact with each other, but having one or more additional elements between the coupled elements. Further, as used herein, securing one element to another element can include direct securing and indirect securing. Additionally, as used herein, “adjacent” does not necessarily denote contact. For example, one element can be adjacent another element without being in contact with that element.

As used herein, the phrase “at least one of”, when used with a list of items, means different combinations of one or more of the listed items may be used and only one of the items in the list may be needed. The item may be a particular object, thing, or category. In other words, “at least one of” means any combination of items or number of items may be used from the list, but not all of the items in the list may be required. For example, “at least one of item A, item B, and item C” may mean item A; item A and item B; item B; item A, item B, and item C; or item B and item C. In some cases, “at least one of item A, item B, and item C” may mean, for example, without limitation, two of item A, one of item B, and ten of item C; four of item B and seven of item C; or some other suitable combination.

Unless otherwise indicated, the terms “first,” “second,” etc. are used herein merely as labels, and are not intended to impose ordinal, positional, or hierarchical requirements on the items to which these terms refer. Moreover, reference to, e.g., a “second” item does not require or preclude the existence of, e.g., a “first” or lower-numbered item, and/or, e.g., a “third” or higher-numbered item.

As used herein, a system, apparatus, structure, article, element, component, or hardware “configured to” perform a specified function is indeed capable of performing the specified function without any alteration, rather than merely having potential to perform the specified function after further modification. In other words, the system, apparatus, structure, article, element, component, or hardware “configured to” perform a specified function is specifically selected, created, implemented, utilized, programmed, and/or designed for the purpose of performing the specified function. As used herein, “configured to” denotes existing characteristics of a system, apparatus, structure, article, element, component, or hardware which enable the system, apparatus, structure, article, element, component, or hardware to perform the specified function without further modification. For purposes of this disclosure, a system, apparatus, structure, article, element, component, or hardware described as being “configured to” perform a particular function may additionally or alternatively be described as being “adapted to” and/or as being “operative to” perform that function.

The schematic flow chart diagrams included herein are generally set forth as logical flow chart diagrams. As such, the depicted order and labeled steps are indicative of one example of the presented method. Other steps and methods may be conceived that are equivalent in function, logic, or effect to one or more steps, or portions thereof, of the illustrated method. Additionally, the format and symbols employed are provided to explain the logical steps of the method and are understood not to limit the scope of the method. Although various arrow types and line types may be employed in the flow chart diagrams, they are understood not to limit the scope of the corresponding method. Indeed, some arrows or other connectors may be used to indicate only the logical flow of the method. For instance, an arrow may indicate a waiting or monitoring period of unspecified duration between enumerated steps of the depicted method. Additionally, the order in which a particular method occurs may or may not strictly adhere to the order of the corresponding steps shown.

The present subject matter may be embodied in other specific forms without departing from its spirit or essential characteristics. The described examples are to be considered in all respects only as illustrative and not restrictive. All changes which come within the meaning and range of equivalency of the claims are to be embraced within their scope.

What is claimed is:

1. A ribbon cable, comprising:
a plurality of wires, each wire of the plurality of wires being a different wire type of a plurality of wire types relative to a wire type of at least another wire of the plurality of wires, wherein each one of the plurality of wires comprises:
a conductor; and
an outer insulating layer surrounding a perimeter of the conductor, wherein the outer insulating layer of a first wire comprises a portion located between the conductor of the first wire and the conductor of a second wire adjacent to the first wire; and
an adhesive material exterior to the outer insulating layer of each wire of the plurality of wires and bonding together the plurality of wires.

2. The ribbon cable of claim 1, wherein the plurality of wire types comprises at least one of the following: solid wire, stranded wire, coaxial cable, twisted pair cable, fiber optic cable, or any combination thereof.

3. The ribbon cable of claim 1, wherein an outer insulating layer of a first wire of the plurality of wires is made of a first material and an outer insulating layer of a second wire of the plurality of wires is made of a second material different from the first material.

4. The ribbon cable of claim 1, wherein the adhesive material comprises an acrylic, UV-curable material.

5. The ribbon cable of claim 1, wherein a first wire of the plurality of wires is arranged substantially parallel and co-planar with a second wire of the plurality of wires.

6. The ribbon cable of claim 1, wherein:
at least one wire of the plurality of wires comprises a number of wires twisted together; and
each wire of the number of wires comprises a conductor, a dielectric layer, and an outer insulating layer.

7. The ribbon cable of claim 1, wherein the plurality of wires comprise one or more wires located between two twisted wires.

8. The ribbon cable of claim 1, wherein the outer insulating layer of at least one wire of the plurality of wires is made of polyethylene.

9. The ribbon cable of claim 1, wherein the adhesive material has a Young's modulus not greater than 4.0.

10. The ribbon cable of claim 1, wherein each wire of the plurality of wires further comprises:
a metallic layer disposed between the outer insulating layer and the conductor; and
a dielectric material disposed between the metallic layer and the conductor.

11. The ribbon cable of claim 1, wherein the adhesive material bonds together the plurality of wires intermittently along a length of the ribbon cable.

12. A method of manufacturing a ribbon cable, comprising:
shaping, via a first die of a die assembly, a plurality of wires into a ribbon cable having a first shape;
applying an adhesive material onto the plurality of wires, the adhesive material comprising a UV-curable acrylic material;
removing a portion of the adhesive material from the wires of the plurality of wires by moving the plurality of wires through a felt layer of the die assembly;
adjusting, via a second die of the die assembly, a shape of the plurality of wires from the first shape to a second shape; and
curing the adhesive material by exposing the adhesive material 120 to a light source for a time interval.

13. The method of claim 12, wherein the light source is a UV light source coupled to the die assembly.

14. The method of claim 13, further comprising exposing the adhesive material to an additional UV light source for an additional time interval, wherein:
the additional UV light source is separate from the die assembly; and
the additional time interval is greater than the time interval.

15. The method of claim 12, further comprising applying the adhesive material between a first wire of the plurality of wires and a second wire of the plurality of wires.

16. The method of claim 12, further comprising applying the adhesive material to the plurality of wires such that the adhesive material surrounds the plurality of wires.

17. The method of claim 12, further comprising opening the die assembly to receive the plurality of wires between a first plate of the die assembly and a second plate of the die assembly.

18. The method of claim 12, further comprising adjusting a pressure level used to remove the portion of the adhesive material based at least in part on a pre-determined cable fillet size.

19. The method of claim 12, further comprising forming an outer insulating layer around each wire of the plurality of wires prior to applying the adhesive material.

20. A system, comprising:
a die assembly, comprising:
a first plate;
a second plate comprising a groove configured to receive a plurality of wires;
a first die coupled to the second plate and comprising a first groove corresponding to a pre-form shape of a ribbon cable;
a reservoir located to intersect the plurality of wires when the plurality of wires are received by the second plate;
an applicator configured to feed an adhesive material into the reservoir;
a felt layer configured to remove a portion of the adhesive material the plurality of wires; and
a second die comprising a second groove corresponding to a final-form shape of the ribbon cable;
an ultraviolet (“UV”) light source coupled to the first plate and configured to partially cure the adhesive material by exposing it to UV light for a time interval; and
additional UV light sources configured to further cure the adhesive material.
